(19) United States
(12) Patent Application Publication
(10) Pub. No.: US 2012/0227021 A1
(43) Pub. Date: Sep. 6, 2012

(54) METHOD FOR SELECTING A TEST CASE AND EXPANDING COVERAGE IN A SEMICONDUCTOR DESIGN VERIFICATION ENVIRONMENT

(76) Inventor: Ninad Huilgol, Fremont, CA (US)

(21) Appl. No.: 13/411,481

(22) Filed: Mar. 2, 2012

Related U.S. Application Data
(60) Provisional application No. 61/448,792, filed on Mar. 3, 2011.
(60) Provisional application No. 61/449,243, filed on Mar. 4, 2011.
(60) Provisional application No. 61/470,962, filed on Apr. 1, 2011.

(51) Int. Cl. G06F 17/50

(52) U.S. Cl. 716/106

(57) ABSTRACT

This invention describes a high level Application Programming interface to interface with block level verification environments. By using simple tasks such as memory_write, memory_read, reg_write and reg_read, the interface becomes user-friendly, and designers as well as verification engineers may be able to write complex test cases using the present invention. This invention also processes generic data objects, generation methods, and comparison methods which are not coupled to the design under verification. Higher level API and objects need not be re-designed from one application to another when using the present invention.

### CROSS-REFERENCE TO RELATED APPLICATIONS

The application claims priority from U.S. Provisional Patent Application No. 61/448,792, filed on Mar. 3, 2011, the contents of which are incorporated herein by reference. The application also claims priority from U.S. Provisional Patent Application No. 61/449,243, filed on Mar. 4, 2011, the contents of which are incorporated herein by reference. This application further claims priority from U.S. Provisional Patent Application No. 61/470,962, filed on Apr. 1, 2011, the contents of which are incorporated herein by reference.

### BACKGROUND OF THE INVENTION

The present invention relates generally to integrated circuits design verification. Specifically, the invention relates to a method for a user-friendly Application Programming Interface (API) for a SystemVerilog-based Semiconductor Design Verification environment.

In integrated circuits (ICs) design, functional verification refers to a type of validation (design verification) method using behavioral models of the circuitry to simulate real world conditions that the circuitry might be expected to encounter. This is called the simulation environment, or the Design Verification Environment.

Two broad types of Design Verification Environments exist. One type is an environment that uses Verilog™ (provided by Gateway Design Automation Corporation of Littleton, Mass., U.S.), which is a Hardware Description Language (HDL) for test cases that are built using a case-by-case approach. This method is older, and considered less sophisticated. The second type of environment uses the High-Level Verification language (HVL) such as SystemVerilog™ (provided by Accellera Organization, Inc. of Napa, Calif., U.S.). In an HVL environment, testing is based on a random generation of test cases based on constraints set by the user. The HVL environment is generally considered to be more sophisticated. The user interface in the HDL method is generally easy to understand by every type of user of that environment, from design engineers to verification engineers. The user interface in the HVL environment is generally harder to understand for design engineers, since design engineers overwhelmingly use Verilog™, which is much simpler to understand than SystemVerilog™. SystemVerilog™ is quickly becoming the preferred choice to build Design Verification environments. This presents the challenge: How can Design Engineers write their test cases in a language and user interface they find very challenging to understand? Moreover, a single test case written by the design engineer needs to be converted into constrained random test case in the SystemVerilog™ based environment. Once this conversion is done, the scope and test coverage of the test case could automatically be expanded, providing significant advantages over the simple, single test case originally written.

Currently, there is no mechanism described to achieve automatic test coverage expansion of a user provided test written with non-SystemVerilog, simple-to-use API. For example, consider a memory controller as a design under verification. Suppose that the user writes a test case where there are three memory write-read pairs, because the user knows that there is a defect within the memory controller design when the above sequence is input to the design under verification. However, the user does not know if there is a related but undiscovered defect for a test sequence of eleven memory write-read pairs. Such defects might remain hidden, since a user cannot possibly think of all permutations and combinations of a test case that has been written.

A user may write a sample test case as follows, with the situation wherein a user may wish to perform seven write-read pairs from AMBA Master 0 to a specific address range (AMBA stands for: Advanced Micro-controller Bus Architecture, introduced by ARM Ltd in 1996). The below example shows the simplicity of the Application Programming Interface (API) as described in the present invention. The user does not have to know the complex SystemVerilog™ features such as constraints, sequences, dynamic objects, etc. The invention converts the test case into a SystemVerilog™ test case automatically, after the test case has been input using this API.

task test_1 (ref int loop_count, input bit base_test_done) begin

| my_event_chain chain; | |
|---|---|
| longint | write_id0; |
| longint | id_dont_care; |

longint master_id, addr, burst_len, data_size, depend_id = −1;
if (!base_test_done)

loop_count = 7;

chain = new( );
for (int i = 0; i < loop_count; i++) begin

addr = 32′h3000_0000 + (i*4);

| | |
|---|---|
| memory_write(0, | // master_id |

| addr, // addr | |
|---|---|
| 8, | // burst_len |

| my_data_pkt::DWORD, //data_size | |
|---|---|
| id_dont_care, | // depend_id for this write |
| write_id0, | // ID assigned to this write |

chain);

depend_id = write_id0;
follower_read (master_id, addr, burst_len,

data_size, depend_id, id_dont_care, chain);

end
queue_of_chains.push_front(chain);

endtask

The design of ICs is increasing in complexity regularly. Timing and power requirements are critical and require adherence to complex timing constraints to ensure proper implementation and realistic timing analysis. More and more transistors are integrated on a single semiconductor device in ever increasing complexity of functions and modules. As the significance of design and manufacturing costs of such ICs have also increased, verifying that the design and corresponding constraints have no flaws (also referred to as bugs) is very important. The verification must be at least substantially, if not completely, operative from the first manufacturing cycle. Designers usually rely on a method that involves manual writing of each test case. This manual test writing process is prone to human limitations, especially as the design and corresponding constraints complexity increases in order to meet functionality, speed, and power requirements of today's complex ICs, and a user simply cannot conceive of all permutations of a test case to cover all aspects of a particular design being verified.

In an attempt to improve the manual, case-by-case test writing process several have proposed Constrained Random Verification methods, where users input their test case not by writing the test case itself, but rather, by defining several constraints within which random test cases are generated by an apparatus. However, the method requires the user to be knowledgeable about SystemVerilog™, the language of choice for Constrained Random Verification, and an industry standard. Design engineers, if they have not used SystemVerilog™ before, are thus at a disadvantage when trying to write tests (constraints). SystemVerilog™ has many features that are not part of Verilog™ (provided by Gateway Design Automation Corporation of Littleton, Mass., U.S.), such as Dynamic Objects, classes that can inherit properties of parent classes, constraints, random stimulus generation and others. There is a tool that is available to generate the random permutations automatically, called “The VMM Scenario Generator,” provided by Synopsys, Inc. of Mountain View, Calif. requires users to be knowledgeable in using SystemVerilog™, and moreover, in the methodology called VMM (Verification Methodology Manual, introduced also, by Synopsys). This deficiency has led to design engineers (as opposed to verification engineers) not widely adopting the use of Synopsys Scenario Generator tool to generate automated test cases.

In view of the deficiencies of the prior art it would be advantageous to provide a solution for IC design constraints verification that overcomes the deficiencies of the prior art.

It would be advantageous to provide a design verification method that would include one or more of the features of 1) an easy-to-use API that allows novice users to write powerful test cases; 2) automatically generating new test stimuli, based on an original test case; 3) executing several variations of the original test case; 4) combining the coverage from all of the variations; and 5) expanding the scope and coverage of the original test case.

### SUMMARY OF THE INVENTION

In one aspect of the present invention, a method for verification of integrated circuit design comprises accessing an integrated circuit design and design limitations, categorizing the design limitations, running verification of the design limitations, generating a report of errors for design limitation failures, correcting a design limitation failure, updating the design limitations, accessing a test bench for integrated circuit design, performing a simulation of the integrated circuit design using the test bench, and generating a report of design limitations.

In another aspect of the present invention, a method for verification of integrated circuit design comprises writing a base test case, including a first event chain, modifying the base test case's event chain to produce modified event chains, pushing the first base test event chain and the modified event chains onto a queue, processing the queue to select a random chain of events, and executing the chain of events.

These and other aspects, objects, features and advantages of the present invention, are specifically set forth in, or will become apparent from, the following detailed description of an exemplary embodiment of the invention when read in conjunction with the accompanying drawings.

### BRIEF DESCRIPTION OF THE DRAWINGS

FIG. 1 is a schematic diagram of the principles of the operation of an exemplary design verification system, according to an embodiment of the present invention;

FIG. 2 is a diagram of an exemplary system for design verification, according to an embodiment of the present invention;

FIG. 3 is an exemplary flowchart of design verification, according to an embodiment of the present invention; and

FIG. 4 is an exemplary flowchart of design verification, according to yet another embodiment of the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

An original test case's coverage may be expanded relative to the focus of the base test case. A fairly large number of new test cases/scenarios may be created from a simple input test case. The present invention provides a method to automatically expand the scope and test coverage of individual test cases in a Semiconductor Design Verification environment.

A test engine's algorithms simplified, in pseudo-code illustrate an exemplary expansion of the test case permutations and variations:

class cov_exp_engine;

function new( );

..

endfunction
task main( );

my_event_chain chain; // chain of events
my_data_pkt data_pkt;
bit all_scenarios_done = 0;
my_event_chain queue_of_chains[$]; // Queue of chains
dep_fields dep_hash_table[*]; // event ‘billboard’ for

// looking up dependent
// events

register_scenarios( ); // task to know which ones to run
assign_rand_scen_counts( ); // how many times to repeat a

// scenario if needed

for (int i = 0; i < queue_of_chains.size( ); i++) begin

chain = queue_of_chains[i];
for (int j = j; j < chain.packet_queue.size( ); j++) begin

data_pkt = chain.packet_queue[jj];
if (data_pkt.dependency == −1)
// not dependent on other

// events

protocol_channel.put(data_pkt);
// send to protocol

// layer
else begin

if (dep_hash_table.exists(data_pkt.dependency))

wait_queue.push_front(data_pkt);
// wait your turn

end

end

end

endtask : main
// this task is called by the driver as soon as a
// transfer has ended on the protocol layer
task start_all_dependent_xfers(reg [15:0] dep_id);

my_data_pkt data_pkt;
if (dep_hash_table.exists(dep_id)) begin

while (wait_q.size( ) > 0) begin

data_pkt = wait_q.pop_back( );
protocol_channel.put(data_pkt);

end

end

endtask
// task bodies for memory_write( ), memory_read( ),
// follower_write( ), follower_read( ) will exist here
task automatic memory_write(

```
  ref longint port_number,
  ref longint address,
  ref longint burst_length,
  ref longint data_size,
  input longint dependency,
  output longint item_id,
  ref my_event_chain chain
  );
```

my_data_pkt pkt;
pkt = new( );
pkt.randomize( ) with
{

(master_id == −1) −>

```
  amba_mas_id inside
  {′AMBA_VALID_MAS_ID_RANGE};
```

....

(xfer_type == WRITE);

};
pkt.dependency = dependency;
item_id == pkt.item_id;
chain.packet_queue.push_back(pkt);
my_pkt_status[item_id] = NOT_COMPLETED;

endtask : memory_write

task follower_read(

```
  ref longint port_number,
  ref longint address,
  ref longint burst_length,
  ref longint data_size,
  input longint dependency,
  output longint item_id,
  ref my_event_chain chain
  );
```

int index[$];
my_data_pkt pkt;
my_data_pkt dep_pkt;
if (dependency != −1) begin

index = chain.packet_queue.find_first_index( ) with

(item_id == dependency);

if (index.size( ) > 0) begin

dep_pkt = chain.packet_queue[index[0]];

end else

$display([%0t] ERROR:

dependent packet not found!”,$time);

end

pkt = new( );
// fields set to −1 are automatically copied over
pkt.randomize( ) with
{

(master_id. == −1) −>

(amba_mas_id == dep_pkt.master_id);

(master_id != −1) −>

(amba_mas_id == port_number);

....

(xfer_type == READ);

};

if (index.size( ) > 0)

pkt.data = dep_pkt.data;

pkt.dependency = dependency;
item_id = pkt.item_id;
chain.packet_queue.push_back(pkt);
my_pkt_status[item_id] = NOT_COMPLETED;

endtask : follower_read

....
endclass : cov_exp_engine

The effect of creating and simulating the newly minted test cases has the effect of expanding the coverage of the original test case.

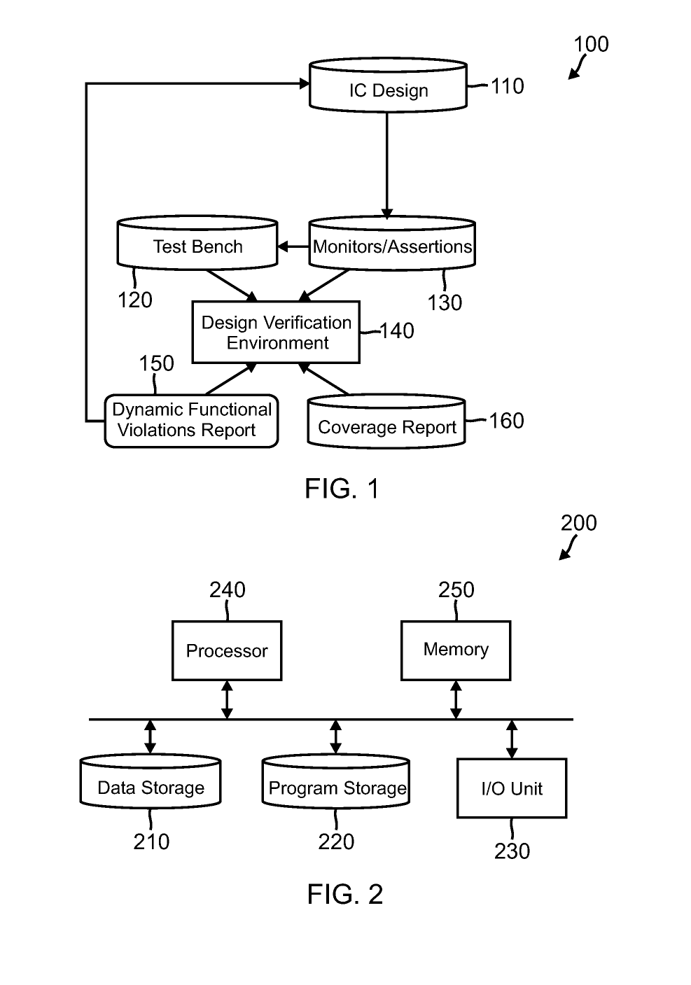

Referring now to the drawings in detail, wherein like reference characters refer to like elements, there is shown in FIG. 1 a schematic diagram 100 of the principles of the operation of a design verification system for an integrated circuit design that may benefit from embodiments of the present invention. It should be understood, however, that the design verification system shown and hereinafter described is merely illustrative of one type of system that may benefit from embodiments of the present invention and, therefore, should not be taken to limit the scope of the present invention. While several embodiments of a design verification system are illustrated and will be hereinafter described for purposes of example, other types of systems and/or devices may employ the present invention.

The IC design and the Synopsis Design Constraint (SDC) files (although other types of constraint or limitation files may be used); containing timing exceptions and other design limitations of the IC may be stored in a database 110. The analysis may explore the connectivity of the design to identify the exceptions that are set between signals which are not connected, or identify the exceptions which are set on signals that are not connected to any output of the design, therefore not influencing the functionality of the design. Additionally the analysis may explore any other connectivity reasons based on which a false path may be considered as false or proved not to be a correct false.

The design verification analysis may use functional engines to explore design functionality to determine if synchronous exceptions are correct or incorrect. Upon detection of any exceptions identified by a verification test, the apparatus reports errors back to the user who may repair the bugs in the database 110, allowing for the correction of the design. One advantage of the above exemplary implementation is that the user, rather than relying upon design assumptions being correct by nature, the user is provided with a tool to independently verify the assumptions by simulating real-world conditions for the design under test.

Monitors and/or assertions 130 may be created in at least one file. The Monitor might be used to report any illegal activity on the buses connecting various agents in the system. The monitors and/or assertions may be combined with a user test bench 120 which may contain test vectors that may uncover further faulty exceptions or corresponding design bugs. A design verification environment (simulation tool) 140 may be based on one of many commercially available design verification methodologies such as VMM (Verification Methodology Manual) or UVM (Universal Verification Methodology) or languages such as SystemVerilog™. The design verification environment 140, exercising the design and user test-bench 120 instrumented by monitors and/or assertions 130 generated by stage one of this apparatus, may then generate a violations report 150 that includes all those exceptions that are now determined to have actual errors. This information may be fed back to the designer so that the IC design 110 is fixed and allowing for the repeat of the cycle again.

In accordance with another exemplary implementation, an exception coverage report 150 may be generated that indicates, for example, the quality of a user test-bench to uncover exception bugs in the IC design. The report 150 may be used by the user and/or an automatic test-bench creation tool to improve the quality of the test-bench 120 for dynamic exception verification. A coverage report 160 may be provided. A coverage report 160 may further be generated for the verification, either on a per iteration basis or otherwise as part of the final coverage report, or any combination thereof.

FIG. 2 depicts an exemplary and non-limiting diagram of a system 200 for design verification according to an embodiment of the present invention. A data storage unit 210 may contain the IC design. A program storage 220 may contain a plurality of programs and a dynamic verification program. According to an exemplary implementation, one or more of the storage units 210 and 220 may be remote to the system 200 and accessed over a network (not shown).

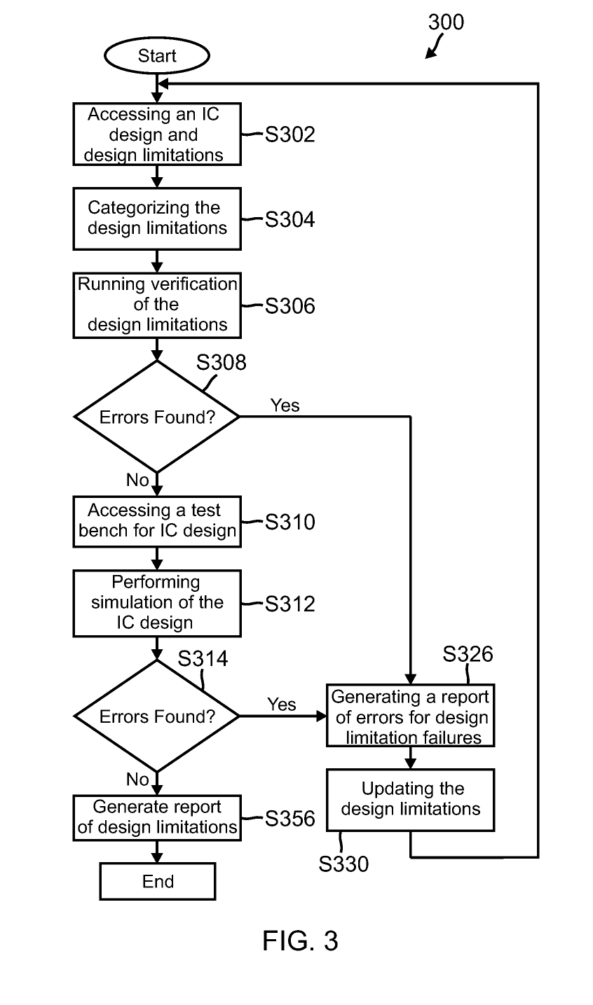

An input/output interface unit (I/O Unit) 230 may enable the system 200 to communicate with other devices over an interface such as a network. Examples of the other devices include, but are not limited to, a user display (not shown), a keyboard (not shown) and other peripheral elements, as may be commonly used by those of ordinary skill in the art. The I/O Unit 230 may be used by a designer to load programs into the program storage 220 or to load a design of an IC into data storage 210. In one exemplary implementation the storage units 210 and 220 are a single storage unit, while in other exemplary implementations a plurality of storage units may be used, each containing other portions needed for the proper operation of the system 200. A processor 240 and a memory 250 may be further used to execute a management program stored in the program storage 220 and performing the functions discussed briefly regarding FIG. 1 above and in more detail regarding FIG. 3 below. The processor 240 may execute instructions stored in program storage 220 using data of the IC design stored in data storage 210, and further using the memory 250 as at least a memory for holding temporary results.

Reference is now made to FIG. 3 that is an exemplary and non-limiting flowchart 300 depicting the design verification flow. In S302 respective files of an IC design, may be accessed, received and/or otherwise fetched. In S304 the design limitations may be categorized to various types of exceptions. In S306 verification of the design limitations may be run. In S308 whether errors have been found is determined and, if errors are found, execution continues with S326; otherwise, execution continues with S310. In S326 an error report may be generated, the report being used in S330 for updating the design limitations failures automatically, semi-automatically, or manually, after which execution continues with S302. Also in S330 or elsewhere, a step of correcting a design limitation failure may be executed. In S310 monitors and/or assertions may be generated for those paths of the design limitations categorized as dynamic and a test bench may be accessed for IC design. In S312 test bench may be received or otherwise fetched, which may be used for the purpose of performing the simulations of the IC design, optionally together with the monitors and/or assertions thereof. Continuing with S312 the simulation may occur to verify one or more suspect design limitations determined to be dynamic. In S314 whether errors were found is determined, and if errors are found, then execution continues with S326; otherwise, execution continues with S356 where an optional report may be provided detailing the design limitation coverage.

In another exemplary implementation a coverage report may be provided in each iteration of a dynamic coverage report may be provided in each iteration of a dynamic verification. Other reporting schemes may be possible without departing from the spirit of the invention. Such implementations, as well as other appropriate reporting are meant to be part of the invention and do not depart from the spirit of the invention. In S326 errors may be related to the dynamic verification step and enable the process for correction of such errors and then repeating the verification process. In an exemplary implementation the dynamic verification process may take place on an iterative basis once the verification was found to be errorless.

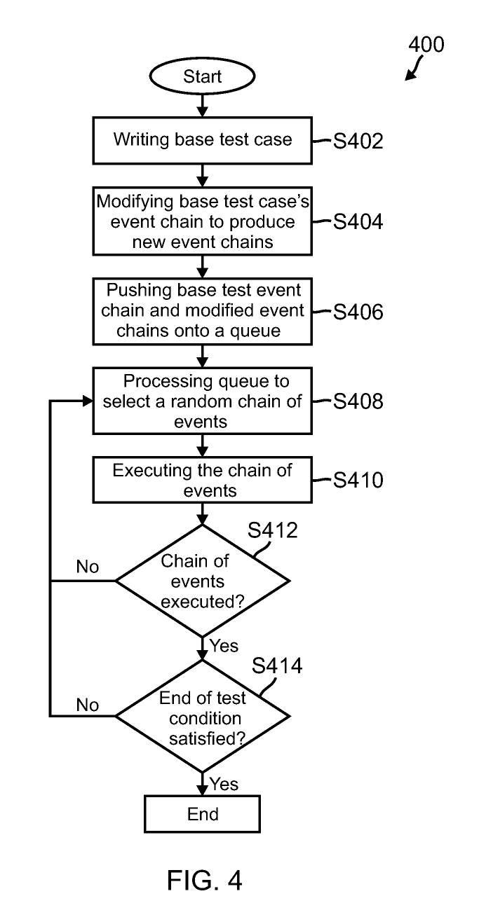

FIG. 4 shows an embodiment of a system 400 according to an embodiment of the present invention. Step S402 may proceed with writing a base test case, including a first event chain. S404 may comprise modifying the base test case's first event chain to produce modified event chains. Pushing the first base test event chain and the modified event chains onto a queue may comprise Step S406. A Step S408 may include processing the queue to select a random chain of events. The chain of events may be executed in Step S410 and in S412 it is determined whether the chain of events was executed. If the chain of events was executed, then the method continues with S414. If not, then execution of the method continues with S408. At S414 it is determined whether the end of a test condition is satisfied. If the answer is “yes,” then the method may end. If the answer is “no,” then execution of the method continues with S408.

It should be understood, of course, that the foregoing relates to exemplary embodiments of the invention and that modifications may be made without departing from the spirit and scope of the invention as set forth in the following claims. Furthermore, a method herein described may be performed in one or more sequences other than the sequence presented expressly herein.

I claim:

1. A method for verification of integrated circuit design, comprising:
accessing an integrated circuit design and design limitations;
categorizing the design limitations;
running verification of the design limitations;
generating a report of errors for design limitation failures;
correcting a design limitation failure;
updating the design limitations;
accessing a test bench for integrated circuit design;
performing a simulation of the integrated circuit design using the test bench; and
generating a report of design limitations.

2. The method of claim 1, further comprising:
causing correction of failed dynamic exceptions;
updating the integrated circuit design; and
updating a design limitations file.

3. The method of claim 2, further comprising:
performing again the method of claim 1.

4. The method of claim 1, further comprising:
generating a report indicating coverage of dynamic verification.

5. The method of claim 1, further comprising:
generating monitors or assertions for limitations; and
performing a simulation of the integrated circuit design using the test bench instrumented with the monitors or assertions.

6. The method of claim 5, further comprising:
collecting errors responsive to the monitors or assertions indicating failure of dynamic limitations.

7. A method for verification of integrated circuit design, comprising:
writing a base test case, including a first event chain;
modifying the base test case's event chain to produce modified event chains;
pushing the first base test event chain and the modified event chains onto a queue;
processing the queue to select a random chain of events; and
executing the chain of events.

8. The method of claim 7, further comprising:
receiving source files which describe a design under test; and
compiling the source files to obtain a simulation kernel.

9. The method of claim 8, further wherein the source files describe the design under test using hardware description language.

10. The method of claim 7, further comprising:
selecting the base test case from a test-case list previously prepared for a test simulation of an integrated circuit design; and
selecting a test scope file for the base test case.

11. The method of claim 10, further comprising:
generating test cases from the test case list.

12. The method of claim 10, further comprising:
determining whether the test case failed; and
identifying and recording the test case as failed, if the test case is determined to have failed.

13. The method of claim 10, further comprising:
performing again the method of claim 7.

14. The method of claim 7, wherein the method is implemented in a design verification environment configured to test integrated circuits.

15. The method of claim 7, further comprising;
generating a dynamic functional violations report.

16. The method of claim 7, wherein at least one test case is defined in a test bench.
